(19) United States
(12) Patent Application Publication
(10) Pub. No.: US 2007/0073677 A1
(43) Pub. Date: Mar. 29, 2007

(54) SYSTEM AND METHOD FOR ACCESSING COMPUTER FILES, USING LOCAL LINKS AND PRINTED SYMBOLS

(76) Inventor: Thierry Lamouline, CHATOU (FR)

Correspondence Address: YOUNG & THOMPSON, 745 SOUTH 23RD STREET, 2ND FLOOR, ARLINGTON, VA, 22202, US

(21) Appl. No.: 10/546,383

(22) PCT Filed: Feb. 24, 2004
(86) PCT No.: PCT/FR04/00411

§ 371 Date: Aug. 11, 2006

(30) Foreign Application Priority Data
Feb. 27, 2003 (FR) 03/02402

(51) Int. Cl. G06F 17/30

(52) U.S. Cl. 707/5; 707/6

(57) ABSTRACT

A document management system includes: a symbol (5); a publication (4) to which the symbol (5) is affixed; a computer file with which the symbol (5) is unequivocally associated; a computer (1) or a computer network which can be accessed by the computer (1) containing the file; a reader (2) which can read the symbol affixed to the publication, the reader (2) being connected to the computer (1); and a tool for processing the symbol (5), which is disposed on the computer (1) or on the local network to which the computer (1) is connected, in order to open the computer file associated with the symbol (5).

Methods making it possible to associate with printed symbols a correspondence with a computer object are known.

Such is, for example, the case for bar codes, which make it possible, via a computer processing system (that of a cash till for example), to associate said code with the reference and with the price of a product.

The need is apparent to implement a Computer Object—for example the opening of an application and/or of a computer file—present on the hard disk of a personal computer (PC) or on the hard disk of a computer present on a network to which said PC is connected, by the use of a symbol printed on a document, said symbol having been generated from said PC or from a computer present on the local network to which said PC is connected.

It is possible to encode the access path to the file to be opened in the symbol itself, but the size of this access path would then be limited by the dimension of the symbol, and no persistence link would exist between the symbol and the file if the latter were to change name and/or access path.

A means of rendering the size of the access path independent of the dimension of the symbol is to use an indirection between the symbol and the file, effected by means of a correspondence table “code of the Symbol/File”, as described in document FR-A-2805359.

However, such a table, though it makes it possible to resolve an access path of a variable and unlimited size by the dimension of the symbol, does not make it possible to automatically guarantee a persistence link between the symbol and the file were the latter to change name and/or access path.

The aim of the present invention is, within the context of the local environment of a computer, in particular of a PC, to associate a printed symbol and a computer file by way of a dynamic association table, that is to say one which ensures in real time and without the intervention of a human operator, persistence between said symbol and said file were the latter to change name and/or access path.

According to an aspect of the invention, the method of managing documents comprises the following steps:
a manager or user of a computer creates a symbol, affixes said symbol to a publication recorded on said computer, and associates said symbol in an unequivocal manner with a computer file present on said computer or a computer network, the association being effected by means of a correspondence table present on said computer,
the user reads the symbol affixed to the publication by means of a reader linked to said computer, or to the local computer network to which said computer is connected, and said computer or local computer network processes said symbol in order to open the computer file associated with the symbol.

The symbol may be affixed to a publication of the computer file with which it is associated.

In one embodiment of the invention, a plurality of symbols are affixed to a publication, each symbol being associated with a different computer file.

In one embodiment of the invention, said symbol. is printed on a publication.

In one embodiment of the invention, after reading of the symbol by the reader, and decoding of said symbol by said reader and/or computer or local computer network, said computer or local computer network searches, in a specific local correspondence table, for an access path to a file associated with a code contained in the symbol, and if it finds it, opens said file designated by said access path.

The correspondence table making it possible to associate the codes and the paths for accessing the files may be dynamic, in the sense that the access path to each file is automatically updated in case of relocation or of renaming of said file on the computer or local computer network.

Said correspondence table may be rendered read-accessible to other computers present on the local network to which said computer is connected. The symbol affixed to a publication may be associated with the computer file of said publication, which file is recorded on said computer. The generation of said symbol, the association of said symbol with said file in said correspondence table, and the affixing of said symbol into said file, may be effected automatically by said computer.

A plurality of symbols may be affixed to a publication, each symbol being associated with a different computer file.

The generation of said symbols, the association of said symbols with said files in said correspondence table, and the affixing of said symbols into said publication, may be effected automatically by said computer on the occasion of the insertion of hypertext links into said publication.

In another embodiment of the invention, after reading of the symbol by the reader, and decoding of said symbol by said reader and/or computer or local computer network, said computer or local computer network searches, in a determined folder present on said computer or local computer network, for a shortcut file designating a file, the name of the shortcut file containing a code contained in the symbol, and if it finds it, opens said file designated by said shortcut file.

The name of the extensionless shortcut file may be said code.

In one embodiment of the invention, the code contained in the symbol consists of two parts, one designating the application to be used to process the other, and, the other being the code making it possible to access the file. A determined value of at least one of the parts of the code may designate an application for accessing files by way of a correspondence table situated on the computer or the local network to which the computer is connected.

Another determined value of at least the first part of the code may also designate an application for accessing files by way of a correspondence table situated on an external computer network (for example Internet).

Another determined value of at least the first part of the code may also designate an application for numbering, within the sense of a keystroke, of all or part of the other part of the code.

In one embodiment of the invention, mail attachments are managed by printing a mail attachment with a symbol associated with said mail in such a way that subsequently the reading of the symbol printed on the publication of the attachment makes it possible to retrieve said mail and, if appropriate to effect a determined operation associated with said mail. The reading of the symbol printed on the publication of the attachment may make it possible to open said mail so as to reply thereto.

The invention also relates to a system for managing documents, comprising a symbol, a publication to which the symbol is affixed, a computer file whose access path is associated with the symbol in an unequivocal manner by means of a correspondence table, a computer or a computer network accessible by the computer on which said correspondence table is present, a reader able to read the symbol affixed to the publication, said reader being linked to said computer, and a tool for processing said symbol in order to open the computer file associated with the symbol.

The correspondence table making it possible to associate the codes and the paths for accessing the files may be dynamic, in the sense that the access path to each file is automatically updated in case of relocation or of renaming of said file on the computer or local computer network to which said computer is connected.

In one embodiment of the invention, the specific local correspondence table containing an access path to a file associated with a code contained in the symbol, said computer or local computer network being able, after reading of the symbol by the reader and decoding, to search in said specific local table for said access path and, if it finds it, to open said file designated by said access path.

In one embodiment of the invention, the operation comprises the opening of a file on a PC by reading, with a suitable reader, a symbol printed on a document generated and printed from said PC.

In another embodiment of the invention, the operation comprises the opening of a file on a PC by reading, with a suitable reader, a symbol printed on a document generated and printed from a computer present on the local network to which said PC is connected.

In one embodiment of the invention, the operation comprises the opening of a file on a PC by reading, with a suitable reader, a symbol printed on a printed version of said file.

In one embodiment of the invention, the operation comprises the opening of a file on a PC by reading, with a suitable reader, a symbol printed on a document, said symbol having, automatically or otherwise, been inserted into the file of said document during the use of the hyperlink insertion function such as present in certain office applications, such as the “Insert/Hypertext link” function from Microsoft® Word®.

The table may feature in a file of the PC or, for example, in the latter's register base if its operating system is Microsoft® Windows®.

The manner of operation of this table is as follows: when a symbol is associated with a target file, a “code of the symbol/access path to the file” correspondence is created in the table.

In the case of a target file of the local space, with each modification of the access path to said target file (including the modification of the name of the target file), the “access path to the file” information is automatically modified, through a software method, so as to integrate the new characteristics of the access path.

In one embodiment of the invention, this automatic update may be performed by utilizing the information associated with said file and contained in the bases managed by the operating system of the PC. In the Microsoft® Windows® world, this update may advantageously be carried out by utilizing the contents of the register base of the operating system.

In another embodiment of the invention, the link between the code of the symbol and the file may be effected through the implementation of an innovative usage of the “shortcut” or “alias” function already existing on certain traditional PC operating systems (respectively Microsoft® Windows® and Mac OS®). In the case of a target file of the local space, the shortcut makes it possible in fact not only to implement the correspondence between the symbol and the target file, but also to resolve the problem of persistence between the two if the target file is renamed or relocated within its volume. The “code of the symbol/access path to the file” correspondence is then equivalent to the correspondence between the name of the shortcut, containing the code of the symbol, and the parameter for accessing the target file associated with the shortcut. In this case, the dynamic correspondence table is simply a folder containing all of the shortcuts used as links between a symbol and a target file, the operating system being the guarantee of the persistence link between the shortcuts and their targets.

The generation of a shortcut on a PC consists in creating a file whose sole function is to point to an application or a document present on the PC, on the local network to which the PC is connected, or on a computer network to which the PC is connected, for example Internet, then to place this shortcut at an easily accessible level of the tree of the file system of the PC.

It then suffices to open this shortcut, for example by positioning the cursor of the mouse on the icon and by clicking rapidly twice with the aid of the button of the mouse to immediately open the application and/or the target document corresponding to said shortcut, regardless of where on the PC, on the local network, or on the computer network to which the PC is connected, said application and/or said target document is stored.

The present method applies to the opening of any type of file contained on a PC or on a volume accessible from a PC, and is especially suited to the immediate opening of a file from its printed copy.

The definitions of the terms used are as follows:
PC: personal computer which can access the application and/or the file to be opened,
local network: a group of computers (personal computers, servers, etc.) linked together by any set of means of connection whatsoever, in which each computer is linked computerwise to each of the others by the use of suitable computer protocols (Ethernet for example),
printout: a document in its printed form,
file: a document, an executable program or else a folder, in its computer form; a priori, a file resides either on the PC, or on the local network, but by extension, designates a file present on a network accessible by the PC, for example the Internet,
folder: a computer tree element such as managed by the computer operating systems, and intended to contain files,
volume: the physical medium containing the file to which the present method is applied (hard disk of a PC or of a server shared on the local network, etc.),
local space: the whole set of volumes which are at least read-accessible and present on the local station and/or on the local network; more generally the PC and local network set, or the PC alone if it is not connected to a local network,
symbol: a graphical symbol, for example a mono- or multidimensional bar code, intended to appear on a printout, decodable with the aid of an appropriate read peripheral,
correspondence table: a computer repository able to store “symbol codes/file access path” pairs and to make it possible to ascertain, by application of a suitable computer request, one of the elements of the pair when the other is available,
dynamic correspondence table: a correspondence table as described above and able to automatically update the access path to a file present on the local space when the latter is modified,
shortcut: a file whose only role is to constitute a link to a file, such as described hereinabove (if the file is on the Internet, the shortcut is then said to be “an Internet shortcut”. The term “shortcut” designates either the objects called “shortcuts” in the Microsoft® Windows® environment, “alias” in the Mac OS® environment, or any other vocabulary designating, in other environments, an equivalent functionality.

The invention has the triple advantage of allowing:
the opening of a file automatically on the basis of a symbol on a printout;
on certain operating systems including Microsoft® Windows®, the persistence of the link between the symbol and the file in case of relocation or change of name, subsequent to the creation of the symbol, of said file in the local space where it was initially recorded;
and, in certain embodiments of the invention, the automatic insertion of the symbol into the document to be printed.

The method is based on:
the creation of a symbol corresponding in an unequivocal manner to a file present on a PC, on one of the constituents of the local network of which the PC forms part, or else corresponding to an address on a computer network to which said PC is connected (for example Internet);
the recording in a dynamic association table, on the one hand of the code associated in an unequivocal manner with said symbol, and on the other hand of the access path to said file;
the printing of said symbol on a printout;
the reading of said symbol by means of a suitable peripheral associated with said PC, and the processing by said PC so that said file corresponding to said symbol is opened on the PC on completion of the reading of the symbol.

For example, the symbol may be a mono- or bidimensional bar code, corresponding or otherwise to an extrinsic standard, such as UPC, EAN, PDF 417, datamatrix, etc.

The reading peripheral may be a suitable bar code reader adapted to the standard chosen for the symbol.

In one embodiment of the invention, the symbol is intended to point to the file of origin of the printout itself, and will therefore advantageously allow the opening of said file on the basis of its printout.

In one embodiment of the invention, the association of the code corresponding to the symbol with the file will advantageously be carried out by means of shortcuts stored in a folder of the volume accessible by the PC.

Provision is then made for:
the creation of a symbol and of the associated shortcut corresponding in an unequivocal manner to a file present on a PC, on one of the constituents of the local network of which the PC forms part, or else corresponding to an address on a computer network to which said PC is connected, for example the Internet,
the printing of the symbol on a printout,
the reading of this symbol by means of a suitable peripheral associated with said PC,
and the processing by said PC so that said file corresponding to said symbol is opened on the PC on completion of the reading of the symbol. The operation of opening the file with the optical reader aimed at the symbol is then equivalent to opening said shortcut.

An aspect of the method is that only the PCs of the local space having a visibility with regard to the shortcuts will have access to the target files pointed at, whether the latter be on the local station, the local network or on a computer network to which said PCs are connected, for example the Internet. On account of the local nature of the shortcuts, the range of the method of reading described here is limited to local usage, that is to say reserved for the PCs of the local space.

A user wishes to associate in an unequivocal manner a symbol, intended to feature on a printout, with a file. This association is intended to be utilizable within a local space of which said PC is a constituent.

At a moment prior to the printing of the printout, a code is determined, automatically or means of a deliberate action. This code may be:
chosen in any manner whatsoever from a library of codes present at a determined location of said local space,
or generated, randomly or otherwise, by software present at a determined location of said local space.

This code is then used in two ways:
on the one hand, a symbol, corresponding in an unequivocal manner to said code, is obtained. This symbol may be chosen from among a library of symbols present at a determined location of said local space, in which library a symbol is associated with a code and one only and in which said code features once and once only or generated from said code by software present at a determined location of said local space.
on the other hand, a “code of said symbol/access path to said file” pair is recorded automatically or by means of a deliberate action in a predefined dynamic association table A present on the hard disk of the PC. Furthermore, this pair may advantageously and automatically be duplicated in another dynamic association table B of the local space, accessible by the other PCs of the local space. This will allow the other users of this space to access the file by way of the printed symbol and of the associated pair in the dynamic association table B.

At each instant, each symbol and its associated code are unique on a given local space. Stated otherwise, the method, through the nature of the determination of the code and of the associated symbol, guarantees that two different files cannot be represented, in the same local space, by the same code and/or by the same symbol.

Next, at a moment prior to the printing of the printout, the symbol is inserted, automatically or by means of a deliberate action, into the file of said printout.

During printing, the symbol then appears in printed form on said printout.

In one embodiment of the invention, the symbol used for this operation is of the same nature as the symbols used for other applications. Its associated code then contains a particular parameter which will make it possible to identify the application presented here and which consists in automatically opening a file of the local station, of the local network, or else of a computer network to which said PC is connected (for example the Internet), by way of a local dynamic correspondence table, implemented for example with shortcuts.

The other applications may be, as a function of the parameterization of the symbol, access to a file, directly or via a remote redirection table (for example on the Internet), or the “keystroke” of all or part of said code according to a numeric, alphanumeric, ASCII format, or any other predefined format. Such a system is capable of addressing several applications on the basis of a symbol containing a parameter making it possible to determine the application with which it is associated.

In one embodiment of the invention, the code associated with the symbol therefore contains two data spaces corresponding to two types of information:
an item of information (n), indicating the nature of the application involved: in this instance, the application is the opening, within the sense of the present invention, of a file associated with said symbol by way of a local dynamic correspondence table, implemented for example with shortcuts, and present on a local space accessible from a PC;
an item of information (p), making it possible to identify, in the dynamic association table of said local space, the relevant access path, associated with said code (p).

In one embodiment of the invention, the user who inserts a hypertext link into his document through the customary tools of his office application (for example the “insert/hypertext link” function from Microsoft® Word®) will see a symbol be juxtaposed with the hypertext link on his screen and/or form an integral part thereof, which symbol will point to the file pointed at by said hypertext link and which will be rendered “active” on the printout of the document through the use of the appropriate optical reading peripheral.

In one embodiment of the invention, the file designates a document able to be printed, the printout will be that of said file, the access path associated with the symbol will be that of said file, and the method will then make it possible to open said file directly from its printout.

In this case, the code or at least a first part of the code will advantageously be able to be generated automatically, for example during the recording of the file with the aid of the “record under” function. The code is then saved automatically in an information field associated in a unequivocal manner with the file, for example in the parameterizable properties of said file within the framework of an application making it possible to fill in fields of parameterizable properties for each document, this operation being transparent to the user.

The symbol may be managed automatically, during the printing of said publication, on the basis of a code corresponding in an unequivocal manner to said file, all or part of said code being recorded in the parameterizable properties of said file within the framework of an application making it possible to fill in fields of parameterizable properties for each document.

This automatic generation has the advantage of not requiring any intervention on the part of the user of the PC.

In one embodiment of the invention, if the file has already been recorded previously, the code is not modified during a subsequent recording of said file.

In one embodiment of the invention, if a file, already previously recorded, is rerecorded under a new name or at a new location on the PC or the local network, a new code is created, which cancels and replaces the previous one.

In one embodiment of the invention, the first part of the code is generated, randomly or otherwise, by software means which ensures that the code does not correspond to a code already existing in the dynamic association table of the local space.

In one embodiment of the invention, the symbol is generated and inserted into the file as soon as the code is generated.

In another embodiment of the invention, the symbol is generated and inserted temporarily into the file only at the moment preceding each printing, then deleted after said printing.

In one embodiment of the invention, each insertion of a symbol into a file where another symbol was previously to be found, cancels and replaces the earlier symbol.

In the embodiment of the invention using a folder containing shortcuts pointing to the target files ensuring the dynamic association table function, the name allocated to a shortcut contains at least, in a predefined manner, all or part of the code associated with the symbol. This shortcut is stored in a predefined directory A of the hard disk of the PC. Furthermore, this shortcut may advantageously and automatically be duplicated in a directory B of said local space, visible from the other PCs of the local space. This will allow the other users of this space to access the file by way of the printed symbol and of the associated shortcut in the directory B.

The operation of reading the symbol and of opening the file comprises the opening on a PC, on the basis of a printout on which a symbol features, of a file present on said PC, on the local space or on a computer network to which said PC is connected, for example the Internet, by way of a dynamic correspondence table, implemented for example with shortcuts accessible by said PC. This operation presupposes that the symbol has been generated by said PC or by another computer of the local space accessible by said PC. In the latter case, this operation furthermore presupposes that the “code of the symbol/access path to the file” pair or the shortcut associated with said symbol is present in the table or the directory B of the local network described hereinabove, that this table or this directory is known to the PC, and that the target file is on a shared file area accessible by said PC, or on a computer network to which said PC is connected, for example the Internet.

The PC is equipped with a means of reading the symbol. For example, if the symbol is a bar code, the means of reading may be a bar code reader capable of reading and, alone or jointly with the PC, of interpreting said bar code, in particular of determining the code associated with said bar code. This determination is carried out in full on the reading peripheral, in full on the PC, or by any combination whatsoever of the two.

In the embodiment of the invention using a folder containing shortcuts pointing to the target files so as to ensure the dynamic association table function, a request utilizing said code is then generated at the level of the operating system by a software means so as to resolve the target file of the shortcut corresponding in an unequivocal manner to said code and present in the predetermined folder or folders A and B of said local space. Assuming the existence of a folder B of the local network accessible at the moment of the symbol reading, said software explores one of the folders A or B by priority and then, if the shortcut is not present in said folder, the other folder B or A. This action then triggers the opening of the file, by way of the traditional function of the shortcut, and does so in a manner transparent to the user.

In one embodiment of the invention, the code may consist of two parts (n) and (p), the part (n) allowing the PC to determine which application is associated with the symbol read, and, in the case of an application of opening a file according to the present invention, the part (p) making it possible to determine in an unequivocal manner which file is involved.

In one embodiment of the invention, the part (p) corresponds to all or part of the extensionless name of a shortcut present in a determined folder A or B of said local space, the shortcut making it possible to point directly at the file. The method then makes provision to open the file whose shortcut present in said folder A or B contains, according to a defined rule, the code part (p) in its name. The term extension is understood to mean a group of characters preceded by a dot itself preceded by the name of a file, for example “file.doc”.

The present invention will be better understood on studying the detailed description of a mode of embodiment taken by way of wholly nonlimiting example and illustrated by the appended drawings, in which:

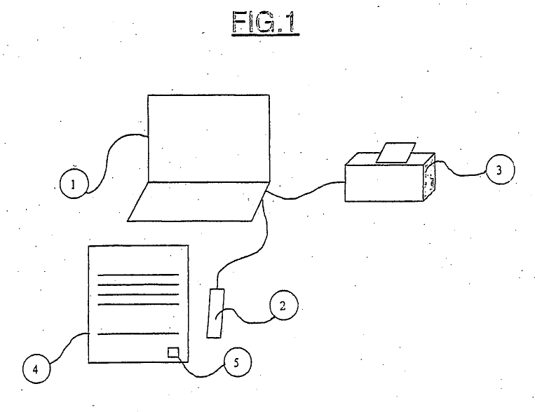

FIG. 1 is a diagrammatic view of a monostation system according to an embodiment of the invention;

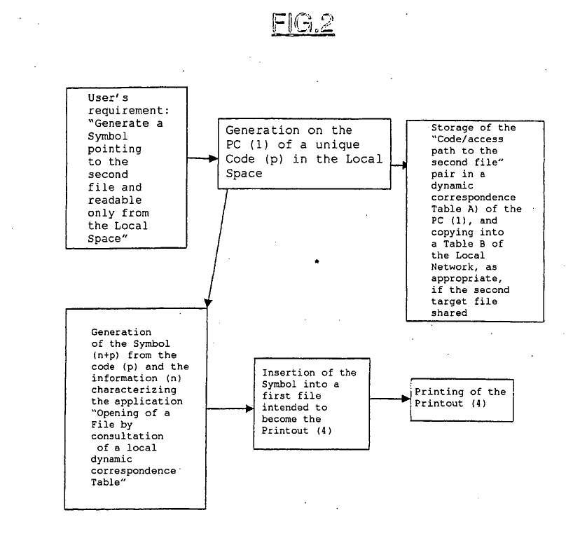

FIG. 2 illustrates the generation of a symbol in the case of association of the said symbol with a file;

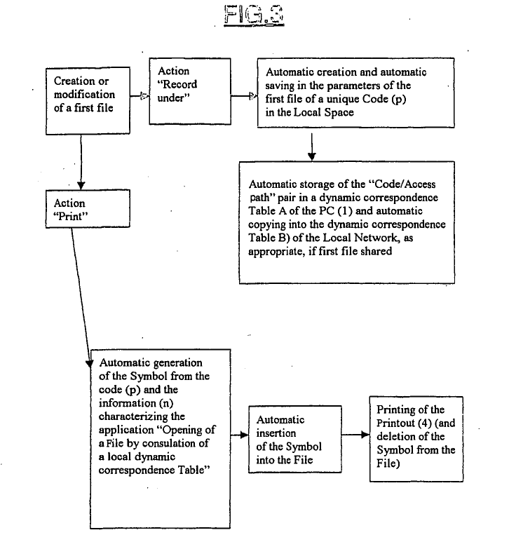

FIG. 3 illustrates the generation and the insertion of a symbol according to a particular embodiment of the invention;

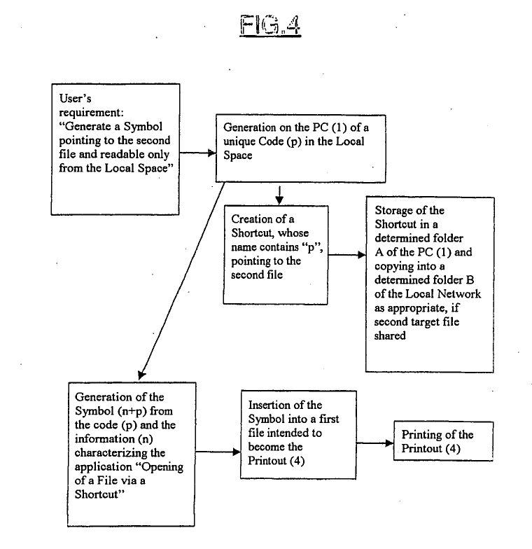

FIG. 4 illustrates the generation and insertion of a symbol with shortcut according to an embodiment of the invention;

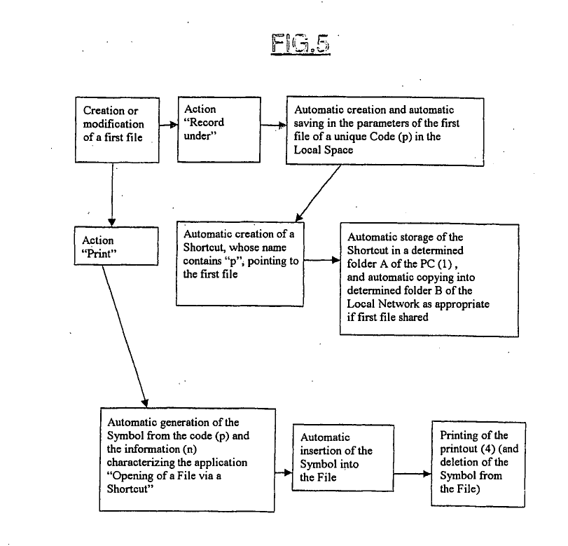

FIG. 5 illustrates the generation and the insertion of a symbol with shortcut according to another embodiment of the invention;

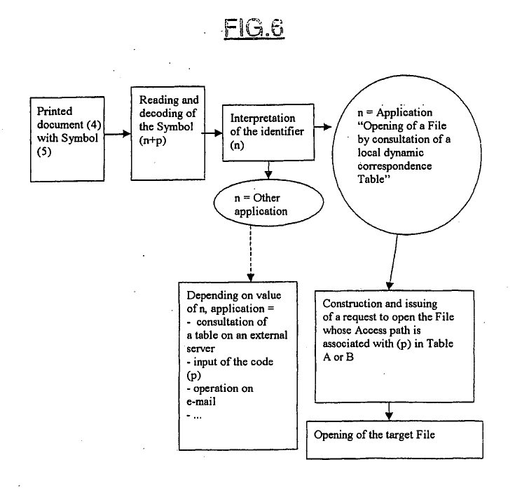

FIG. 6 illustrates the reading of a symbol and the opening of the file pointed at;

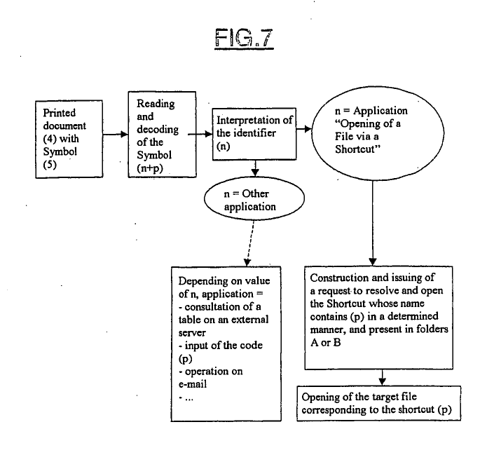

FIG. 7 illustrates the reading of a symbol and the opening of the file pointed at by a shortcut; and

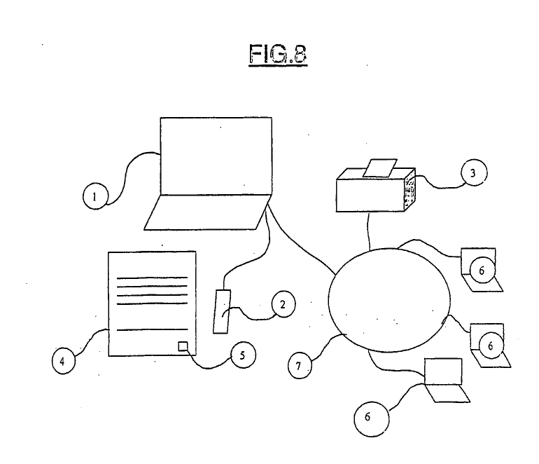

FIG. 8 is a diagrammatic view of a local network system according to an embodiment of the invention.

The user is furnished with an individual computer, or PC 1, equipped with a reading peripheral 2 and connected by any means whatsoever to a printing peripheral 3.

A symbol 5 has been created within the sense of the present invention, and inserted into a first file by the PC 1. This may be a symbol pointing at a second file present on said PC or on a computer network accessible by said PC (for example the Internet) (FIG. 2); or a symbol pointing at the first file itself (FIG. 3), inserted, automatically or otherwise, for example marginal to the footer.

The first file has been printed on the printer 3, hence the printout 4.

In a particular case of FIG. 2, the symbol is created automatically on the occasion of the creation of a hypertext link and has as target the second file pointed at by said hypertext link of which it becomes an integral part: in the document, it then takes the place of the hypertext, or else is juxtaposed therewith. In this particular case, all the operations described in FIG. 2 will advantageously be carried out in an automatic manner transparent to the user.

FIG. 3 corresponds to FIG. 2 in the particular case of the insertion of a symbol onto the target file itself.

FIGS. 4 and 5 correspond respectively to FIGS. 2 and 3, in the particular case of the invention using shortcuts.

On his PC 1, the user now wishes to open simply the second file pointed at by the printed symbol, whether it be present on the PC 1 or on a computer network accessible by said PC 1 (for example the Internet if the PC 1 is furnished with an Internet connection).

It then suffices for the user to position the reading peripheral 2 suitably vis-à-vis the symbol 5, and to trigger the operation of reading the symbol 5 by the reading peripheral 2.

This operation entails the interpretation of the symbol 5 by the reading peripheral 2 and/or the PC 1 and leads to the automatic opening of the second file associated with the symbol 5 on the PC 1 (FIG. 6).

FIG. 7 is similar to FIG. 6, but relates to the case of the use of shortcuts.

FIG. 8 illustrates the use of the system in the case of a local network environment.

The user is furnished with an individual computer, or PC 1, equipped with a reading peripheral 2. This PC 1 is in touch with other computers 6 by way of a local network 7. These PCs 1 or 6 are connected to at least one printing peripheral 3 by any means whatsoever.

A symbol 5 has been created, within the sense of the present invention, and inserted into a first file by one of the PCs 1 or 6.

This may be a symbol pointing at a second shared file of the local network, or at a second file present on a computer network accessible by the PC 1 (for example the Internet if the PC is furnished with an Internet connection) (FIG. 2 or 4): or it may be a symbol pointing at said first file itself (FIG. 3 or 5), in which case said first file must reside in shared area so as to be able to be opened on any PC 1 or 6 of the local space.

The first file has been printed on the printer 3 and has become the printout 4.

Here, likewise, in a particular case of FIGS. 2 or 4, the symbol is created automatically on the occasion of the creation of a hypertext link, has as target the second file pointed at by said hypertext link, and is associated, in the first file with said hypertext link so as to be, for example, printed in a manner contiguous with said hypertext link. In this particular case, all the operations described in FIGS. 2 or 4 will advantageously be carried out in an automatic manner transparent to the user.

The only difference with the generation of symbol in a monostation environment resides in the duplication of the “code of said symbol/access path to said file” pair or of the shortcut created, in a table or a folder B of the local network known to the PCS 1 and 6 of the local space whose users wish to share printed documents.

On his PC 1, the user now wishes to open simply the second file pointed at by the printed symbol, whether it be present in the local space or on a computer network accessible by the PC 1, for example the Internet if the PC is furnished with an Internet connection. As previously, it then suffices for the user to position the reading peripheral 2 suitably vis-à-vis the symbol 5, then to trigger the operation of reading the symbol by the reading peripheral. This operation entails the interpretation of the symbol 5 by the reading peripheral 2 and/or the PC 1 and leads to the automatic opening of the second file associated with the symbol 5 (FIG. 6 or 8).

The only difference with the reading of symbol in a monostation environment resides in the additional consultation of the dynamic association table or of the folder B so as to retrieve the “code of said symbol/access path to said file” pair or the shortcut associated with the symbol: if the pair or the shortcut is not found in A, it is searched for in B (or vice versa). The advantage of the duplication of the pair or of the shortcut generated is that it may be retrieved by the creator station if the latter disconnects from the local network.

1. A method of managing documents, in which:
a user of a computer creates a symbol, affixes said symbol to a publication recorded on said computer, and associates said symbol in an unequivocal manner with a computer file present on said computer, the association being effected by means of a correspondence table present on said computer,
the user reads the symbol affixed to the publication by means of a reader linked to said computer, and said computer processes said symbol in order to open the computer file associated with the symbol.

2. A method of managing documents, in which:
a user of a computer creates a symbol, affixes said symbol to a publication recorded on said computer, and associates said symbol in an unequivocal manner with a computer file present on another computer, the association being effected by means of a correspondence table present on said computer,
the user reads the symbol affixed to the publication by means of a reader linked to said computer, and said computer processes said symbol in order to open the computer file associated with the symbol.

3. The method as claimed in claim 1, in which the correspondence table making it possible to associate the codes and the paths for accessing the files is dynamic, in the sense that the access path to each file is automatically updated in case of relocation or of renaming of said file on the computer or local computer network to which said computer is connected.

4. The method as claimed in claim 1, in which said correspondence table is rendered read-accessible to other computers present on the local network to which said computer is connected.

5. The method as claimed in claim 1, in which the symbol affixed to a publication is associated with the computer file of said publication, which file is recorded on said computer.

6. The method as claimed in claim 5, in which the generation of said symbol, the association of said symbol with said file in said correspondence table, and the affixing of said symbol into said file, are effected automatically by said computer.

7. The method as claimed in claim 1, in which a plurality of symbols are affixed to a publication, each symbol being associated with a different computer file.

8. The method as claimed in claim 7, in which the generation of said symbols, the association of said symbols with said files in said correspondence table, and the affixing of said symbols into said publication, are effected automatically by said computer on the occasion of the insertion of hypertext links into said publication.

9. The method as claimed in claim 1, in which after reading of the symbol by the reader, and decoding of said symbol by said reader and/or computer, said computer searches, in a correspondence table present on said computer, for an access path to a file associated with a code contained in the symbol, and if it finds it, opens said file designated by said access path.

10. The method as claimed in claim 1, in which after reading of the symbol by the reader, and decoding of said symbol by said reader and/or computer, said computer searches, in a correspondence table present on a computer of the local network to which said computer is connected, for an access path to a file associated with a code contained in the symbol, and if it finds it, opens said file designated by said access path.

11. The method as claimed in claim 1, in which after reading of the symbol by the reader, and decoding of said symbol by said reader and/or computer, said computer searches, in a determined folder present on said computer, for a shortcut file designating a file, the name of the shortcut file containing a code contained in the symbol, and if it finds it, opens said file designated by said shortcut file.

12. The method as claimed in claim 1, in which after reading of the symbol by the reader, and decoding of said symbol by said reader and/or computer, said computer searches, in a determined folder present on a computer of the local network to which said computer is connected, for a shortcut file designating a file, the name of the shortcut file containing a code contained in the symbol, and if it finds it, opens said file designated by said shortcut file.

13. The method as claimed in claim 11, in which the name of the extensionless shortcut file is said code.

14. The method as claimed in claim 1, in which the code contained in the symbol consists of two parts, a determined value of at least one of the parts designating the application for accessing files by way of a correspondence table situated on the computer or the local network to which the computer is connected, and the other being the code making it possible to access the file.

15. The method as claimed in claim 14, in which another determined value of at least the first part of the code designates an application for accessing files by way of a correspondence table situated on an external computer network.

16. The method as claimed in claim 14, in which another determined value of at least the first part of the code designates an application for numbering, within the sense of a keystroke, of all or part of the other part of the code.

17. The method as claimed in claim 1, in which e-mail attachments are managed by printing a mail attachment with a symbol associated with said mail in such a way that subsequently the reading of the symbol printed on the publication of the attachment makes it possible to retrieve said mail or to effect a determined operation associated with said mail.

18. The method as claimed in claim 17, in which the reading of the symbol printed on the publication of the attachment makes it possible to open said mail so as to reply thereto.

19. A system for managing documents, characterized in that it comprises a symbol (5), a publication (4) to which the symbol (5) is affixed, a computer file whose access path is associated with the symbol (5) in an unequivocal manner by means of a correspondence table, a computer (1) or a computer network accessible by the computer (1) on which said correspondence table is present, a reader (2) able to read the symbol affixed to the publication, said reader (2) being linked to said computer (1), and a tool for processing said symbol (5) in order to open the computer file associated with the symbol (5).

20. The system as claimed in claim 19, characterized in that the correspondence table making it possible to associate the codes and the paths for accessing the files is dynamic, in the sense that the access path to each file is automatically updated in case of relocation or of renaming of said file on the computer or local computer network to which said computer is connected.

21. The system as claimed in claims 19, characterized in that the symbol affixed to a publication is associated with the computer file of said publication.

22. The system as claimed in claim 21, characterized in that the symbol is generated automatically, during the printing of said publication, on the basis of a code corresponding in an unequivocal manner to said file.

23. The system as claimed in claim 22, characterized in that all or part of said code is recorded in the parameterizable properties of said file within the framework of an application making it possible to fill in fields of parameterizable properties for each document.

24. The system as claimed in claim 19, characterized in that a plurality of symbols are affixed to a publication, each symbol being associated with a different computer file.
